(19) United States
(12) Patent Application Publication
(10) Pub. No.: US 2018/0039929 A1
(43) Pub. Date: Feb. 8, 2018

(54) System and Method for Fair Employee Scheduling

(71) Applicant: OTG Experience, LLC, New York, NY (US)

(72) Inventor: Albert C. Lee, New York, NY (US)

(21) Appl. No.: 15/671,538

(22) Filed: Aug. 8, 2017

Related U.S. Application Data
(60) Provisional application No. 62/372,076, filed on Aug. 8, 2016.

(51) Int. Cl. G06Q 10/06

(52) U.S. Cl. CPC G06Q 10/063112; G06Q 10/063118; G06Q 20/20

(57) ABSTRACT

A method for scheduling servers within a food-serving establishment or other business environment using a point-of-sale system based on a fairness processing module. The system includes a tablet, configured to receive a food order, and a computer having a transceiver, memory, and processor. The transceiver receives information about the food order from the tablet including payment and gratuity information. The memory stores payment and gratuity information along with information related to tables statistics and server-table assignments. The computer uses the fairness processing module to provide a preliminary recommendation of a first server from a group of servers for a non-routine scheduling assignment. The fairness processing module is based on a total amount of gratuities the first server has earned during a relevant period of time as compared to a total amount of gratuities earned by other servers in the group of servers.

### STATEMENT OF RELATED CASE

This case claims priority to U.S. Provisional Patent Application Ser. No. 62/372,076 filed on Aug. 8, 2016 (Attorney Docket 3094-004pr1), which is incorporated herein by reference in its entirety.

### FIELD OF THE INVENTION

The invention relates generally to restaurant management and more particularly to the scheduling of food servers.

### BACKGROUND OF THE INVENTION

Scheduling of restaurant wait staff is an important aspect of managing a restaurant. Restaurant management must ensure that a sufficient number of servers are present to service all diners with minimal delay. Poor service often results in a diner's first meal being their last meal at the restaurant. And if an unhappy customer shares the complaint about the service with friends, those friends are unlikely to dine at the restaurant.

Furthermore, scheduling has a major impact on a server's income. In particular, there can be a significant difference in tips as a function of day of the week (e.g. Monday versus Saturday) and time of day (e.g., lunch versus dinner). Consequently, if consistently denied a choice shift, a server suffers an economic penalty. And if a server believes that they are being treated unfairly in this regard, it is likely to impact their on-the-job performance or simply cause them to leave and seek other employment. Either way, it impacts the business.

There are various approaches in the prior art for scheduling a workforce. Most are based on employee performance; that is, a worker is rewarded with a choice shift based on superior on-the-job performance. An example of such an approach is disclosed in US Patent Publication 2012/0323626. This reference discloses a rostering module that is coupled to a POS terminal to generate information indicative of staff performance. A performance score is generated for each staff member based on sales information for the staff member and on aggregate sales information for the business. The rostering module generates a roster for scheduling staff members in scheduling slots based on each staff member's performance score.

In another approach, certain days—fairness days—on which employees might wish not to work, such as a weekend day or a holiday, are identified. An employee that works on a fairness day gets a credit for that day, and the fairness-day credit history is maintained by the system. When employees must be scheduled to work on a subsequent fairness day, the system rank orders employees by taking fairness-day credit and other information into account. US Patent Publication 2008/0300953 discloses a workforce management method that implements fairness-day processing.

In the context of a restaurant, in particular, there are further aspects to scheduling that if not given due consideration can result in unfairness to a server.

### SUMMARY

In accordance with the illustrative embodiment of the invention, a point-of-sale (“POS”) system used in a food-serving establishment includes real-time reporting of information that enables a manager (or the system itself) to allocate food-serving responsibilities among employees in a way that provides an equal opportunity to earn money (i.e., tips). The POS system is applicable for use in food-serving establishments that do not accept cash, such as is becoming increasingly common in, for example, airline terminals.

The POS system disclosed herein can be used for routine scheduling; that is, which servers work on which days and during which shifts. However, unlike most prior-art workforce management systems, embodiments of the present invention can be used, and in fact are primarily directed for us in scheduling situations that are not ordinarily scheduled in advance. As used in the disclosure and the appended claims, the term “non-routine scheduling” refers to scheduling employees to cover for routinely scheduled employees when the routinely scheduled employee takes a break or has to end their shift for a non-scheduled/unforeseen reason (e.g., health issue, emergency, etc.)

Consider, for example, the scheduling issue that arises when a first food server goes on break or has to unexpectedly end their shift. A second server will need to cover the first server's tables. If a manager has a choice among several employees as to who should provide the coverage, how is that choice made?

If the choice is intended to be “fair” to the employee, it should perhaps consider the number of tables that each of the potential covering employees have waited on recently and the amount of tips each of them has made for the day, etc. But the manager does not typically have access to that information. Consequently, the manager makes a decision that, although arbitrary, might be unfair to an employee in the sense that it deprives that employee of the opportunity to make as much money as another server in that restaurant. In a choice between two employees, for the example, the manager might inadvertently select the employee who had earned more in tips as the person to cover for the breaking server.

Or perhaps the manager must assign a first server to handle the tables in the front of the restaurant and a second server to handle those in the back. If business is slow, tables in the front of a restaurant are typically filled before those in the back of the restaurant, so that the restaurant appears to be busy. If the employee who has received less in tips for the day is assigned to handle the tables in the back of the restaurant, that employee is likely to fall even further behind for the day.

A POS system in accordance with the illustrative embodiment accumulates real-time information pertaining to: (1) which server is covering which tables; (2) the food order taken for each table; (3) how quickly tables are turning over (i.e., “order velocity”); and (4) the tip associated a particular order, among other information.

From the accumulated information, the POS system can determine: (A) how many tables each server has seen; (B) how much money in tips each server has earned; (C) tips earned as a percentage of sales for each server; and (D) where patrons are being seated, among other information.

Consequently, in making a recommendation as to who to select for serving assignment, the system can consider item (B), with the intent of increasing the earnings of a particular server. But rather than relying solely on the amount of tips earned, in providing a recommendation, the system takes into account the reason why a particular server is earning less, on given day, than other servers.

It might be a function of items (A) and/or (D), which are unlikely to be under the control of the server. For example, as previously noted, the tables in the front of a restaurant are typically seated before those in the back of the restaurant. If a server has been covering the back of the restaurant during such a time, his tips for the day are likely to have suffered. On the other hand, if one particular server's tips as a percentage of sales (item C) tend to be lower than that of other servers, it could be an indication that the server has a performance problem. As such, if the figure for item (C) is low for a particular server, that might militate against recommending that server for covering duties. Indeed, rewarding that employee with a choice assignment could result in unfairness to other employees as well as negatively affecting the revenues and business prospects of the restaurant.

The real-time information obtained by the POS system can thus be used to assign serving responsibilities in a way that is intended to be fair to all employees. If the workforce understands that duties are assigned in a way that supports this goal, this can be expected to promote employee job satisfaction. If employees are satisfied, their on-the-job performance will reflect it, which is likely to result in a positive dining experience for patrons. And the goodwill from both satisfied workers and satisfied diners accrues to the restaurant and its management. Consequently, a POS system in accordance with the present teachings is expected to provide both social and economic benefits.

An embodiment of the present invention is a point-of-sale system for scheduling servers for a non-routine scheduling assignment by processing payment information, including gratuity, for each table in an establishment using an electronic payment system, the point-of-sale system comprising, a tablet for receiving at least one food order from each table, a transceiver for receiving information about the food order from the tablet and receiving payment information, including the gratuity related to the food order, from the electronic payment system, a memory for storing the received food order information, including the gratuity, a processor that is configured to schedule servers by performing the steps of: (a) creating a rank order of servers based on a total amount of gratuities earned by each server during a relevant period of time, and (b) determining the server that has earned the least amount of gratuities over the relevant period of time and recommending the server to perform the non-routine scheduling assignment.

Another embodiment of the present invention is a computer-implemented method for selecting an employee for a non-routine scheduling assignment based on gratuities earned, the method comprising, obtaining gratuity information for each table within an establishment from an electronic payment system, comparing, by a processor, a total amount of gratuities earned by each employee to a total amount of gratuities earned by other employees in a group of employees to recommend a first employee for a non-routine scheduling assignment, by obtaining the amount of gratuities earned by each employee during a relevant period of time, rank order the group of employees based on the amount of gratuities the employees have earned, determining the first employee from the group of employees who has earned the least amount of gratuities, comparing the amount of gratuity earned by the first employee to a predetermined threshold amount, and recommending the first employee for the non-routine scheduling assignment when the amount of gratuity earned by the first employee equals or exceeds the predetermined threshold amount, and determining whether the first employee should be assigned to the non-routine scheduling assignment when the comparison recommends the first employee.

Yet another embodiment of the present invention is a non-transitory computer readable medium with computer executable instructions stored thereon executed by a processor to perform the method for scheduling employees for a non-routine scheduling assignment based on fairness processing, the method comprising, (a) accessing a database in the computer including at least, information pertaining to a food order, gratuity information associated with the food order, table information, and server information including scheduling preferences and server-table is assignments, (b) comparing, by a processor, a total amount of gratuities earned by each employee to a total amount of gratuities earned by other employees in a group of employees to recommend a first employee for a non-routine scheduling assignment, by calculating, by a statistics generation module in the computer, the total amount of gratuities earned by each employee within the group of employees during a relevant period of time, calculating, by a fairness processing module in the computer, a rank order of the group of employees based on the amount of gratuities the employees have earned during the relevant period of time, and determining the first employee from the group of employees who has earned the least amount of gratuities, comparing, by a scheduler module in the computer, the amount of gratuity earned by the first employee to a predetermined threshold amount, and recommending the first employee for the non-routine scheduling assignment when the amount of gratuity earned by the first employee equals or exceeds the predetermined threshold amount, and (c) determining whether the first employee should be assigned to the non-routine scheduling assignment when the comparison recommends the first employee.

### BRIEF DESCRIPTION OF THE DRAWINGS

FIG. 1 depicts the interior of a restaurant and shows a layout of tables.

FIG. 2 depicts a POS system in accordance with the illustrative embodiment of the invention.

FIG. 3 depicts an architecture of a computer used in the POS system of FIG. 2.

FIG. 4 depicts relevant databases and software modules in the memory of the computer of FIG. 3.

FIG. 5 depicts further detail about the databased and software modules of FIG. 4.

FIG. 6 depicts a flow chart of the operation of a fairness processing module in accordance with an embodiment of the invention.

### DETAILED DESCRIPTION

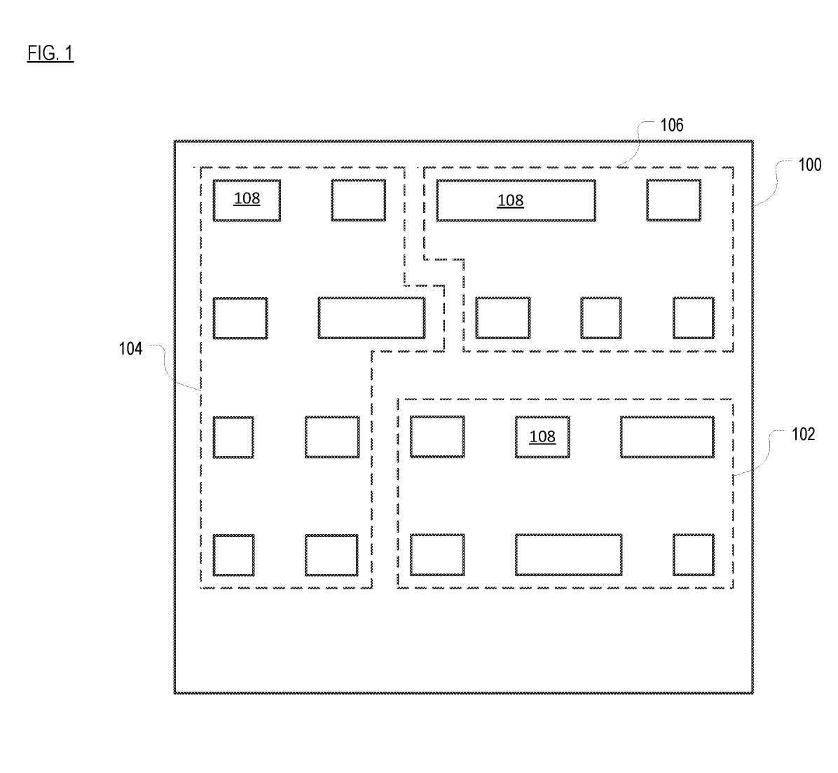

FIG. 1 depicts the interior of restaurant 100 including a plurality of tables 108. The tables are organized into three groups 102, 104, and 106. Tables 108 in group 102 are located relatively closer to the front of the restaurant, tables 108 in group 106 are located towards the rear of the restaurant, and tables 108 in group 104 are located toward the left side of the restaurant and includes tables near the front and back of the restaurant.

The organization of tables 108 into such groups is for operational reasons, including an ability to readily assign servers to the groups. Because restaurants tend to fill seats at the front of the restaurant before those in the rear, tables of group 102 are more likely to be occupied than tables of group 106. This has implications for the servers assigned to these groups of tables. In particular, a server assigned to group 102 is likely to wait on more diners than a server that is assigned to group 106. Consequently, all other things being equal, the server assigned to handle group 102 is likely to earn more tips than a server assigned to group 106.

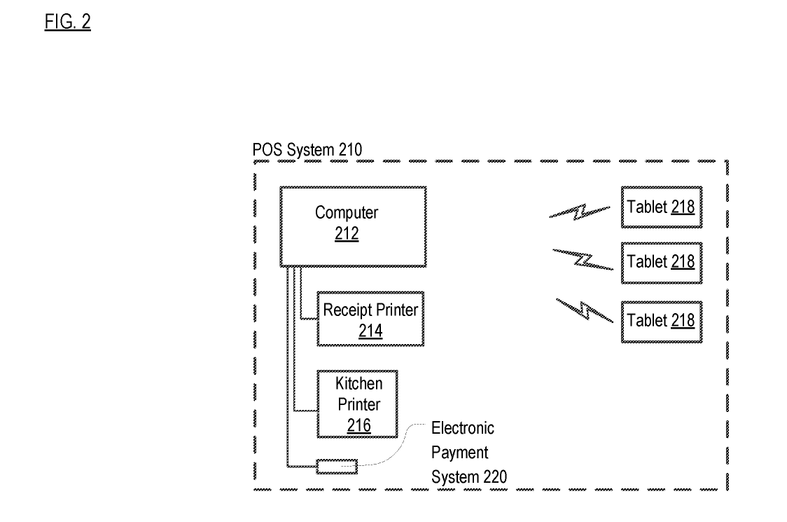

FIG. 2 depicts POS system 210 in accordance with the illustrative embodiment. The POS system includes computer 212, receipt printer 214, kitchen printer 216, a plurality of tablets 218, and an electronic payment system 220. Computer 212 is in communication with all elements of the system. In the illustrative embodiment, printers 214 and 216 and electronic payment system 220 (e.g., credit card swipe, credit card chip readers [EMV], pay-by-phone/watch systems, etc.) communicate with computer 212 via Ethernet while tablets 218 communicate wirelessly (e.g., WiFi, etc.) with the computer. In some embodiments, electronic payment system 220 is incorporated into tablet 218; in such embodiments, the electronic payment system communicates wirelessly with computer 212. It will be appreciated by those skilled in the art that in other embodiments, other communications protocols for supporting communications between various elements of POS system 210, may suitably be used.

Tablets 218, which may be a conventional tablet computer, such as an Apple iPad®, Samsung Galaxy®, Google Nexus®, etc., is appropriately configured (software, etc.) for inputting a food order. In the illustrative embodiment, the order is taken by the serving staff; in some alternative embodiments, patrons themselves can input the food order. The order is wirelessly transmitted to computer 212, which, in turn, transmits the order to kitchen printer 216. The order is printed out via printer 216 for the kitchen staff. In some embodiments, electronic payment system 220 is incorporated with tablets 218.

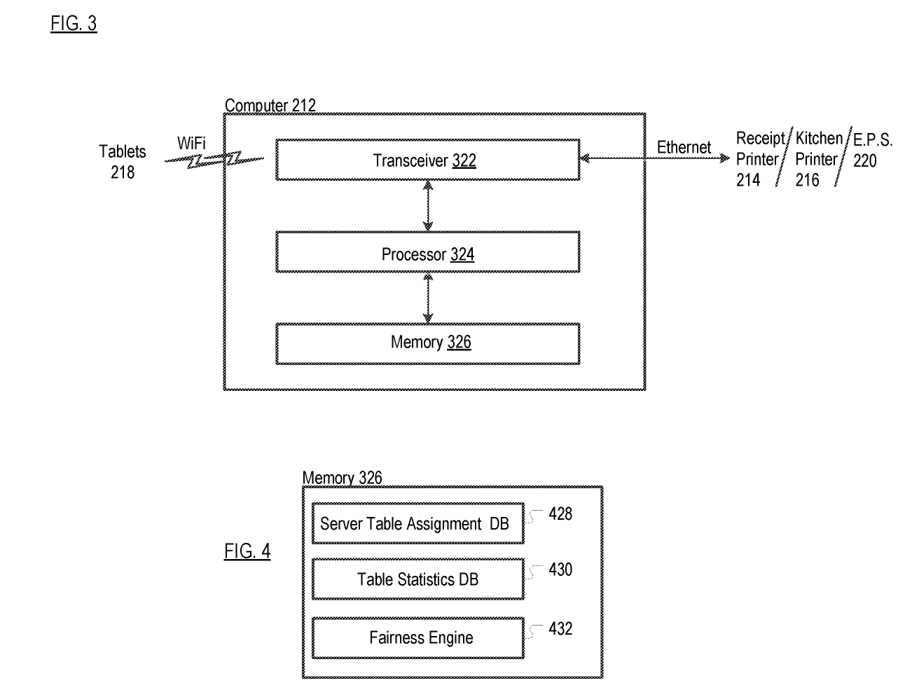

FIG. 3 depicts further detail of computer 212. The computer includes transceiver 322, processor 324, and memory 326. In some alternative embodiments, much or all of the functionality provided by computer 212 can be provided by a cloud-based system. However, for pedagogical purposes, the invention will be presented in the context of a system using local computer 212.

Transceiver 322 enables computer 212 to communicate with the other devices via one or more communications protocols (e.g., Blue-tooth, WiFi, cellular, Ethernet, etc.). It will be clear to those skilled in the art, after reading this specification, how to make and use transceiver 322.

Processor 324 is a general-purpose processor that is capable of, among other tasks, executing an operating system, executing specialized application software used in conjunction with the embodiments of the invention, and populating, updating, using, and managing data in memory 326. In some alternative embodiments of the present invention, processor 324 is a special-purpose processor. It will be clear to those skilled in the art how to make and use processor 324.

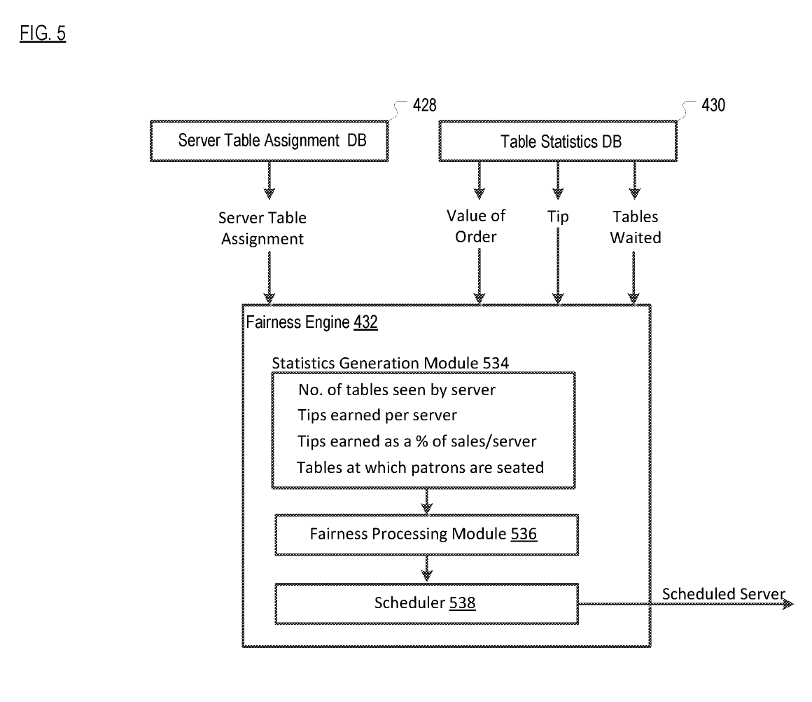

Memory 326 is a non-volatile, non-transitory memory technology (e.g., RAM, ROM, EPROM, EEPROM, hard drive(s), flash drive(s) or other solid state memory technology, CD-ROM, DVD, etc.) that stores, among any other software and data, specialized application software, such as discussed in conjunction with FIGS. 4 through 6, which, when executed, enable processor 324 to perform the features and tasks of the various embodiments of the invention. It will be clear to those skilled in the art how to make and use memory 326.

The term “non-transitory” is to be understood to remove only propagating transitory signals per se from claim scope and does not relinquish rights to all standard computer-readable media that are not only propagating transitory signals per se.

FIG. 4 depicts some of the contents of memory 326; in particular, server table assignment database 428, table statistics database 430, and fairness engine 432, the latter being specialized software.

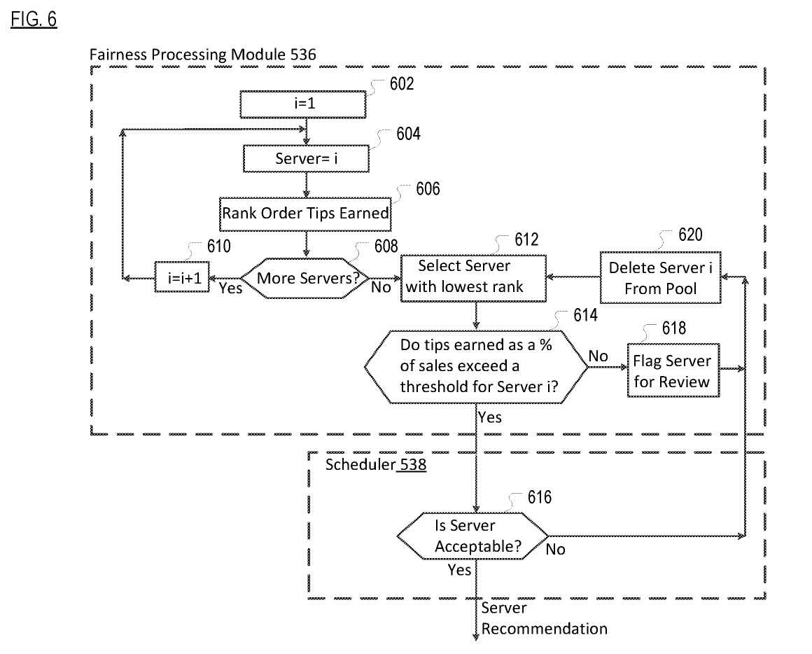

FIG. 5 depicts further information concerning the contents of memory 326 shown in FIG. 4. Server-table assignment database 428 includes information as to which server is assigned to which tables. For example, and referencing FIG. 1, it might include information that a first employee is responsible for tables 108 in group 102, as second employee is responsible for tables 108 in group 104, and a third employee is responsible for tables 108 in group 106.

Table statistics database 430 includes information, on a per table basis, such as (a) the value of the order for each group of diners seated at the table over a relevant period of time (e.g., a shift, a day, etc.), and (b) the amount of the tip awarded to the server for each group of diners at the table over the relevant period of time. Database 430 also includes information concerning the number of tables handled by a particular server in a relevant period of time. The table statistics database is automatically populated via the use of POS system 210.

The information from server table assignment database 428 and table statistics database 430 is accessed by fairness engine 432. In the illustrative embodiment, fairness engine 432, which is a software, includes statistics generation module 534, fairness processing module 536, and schedule 538.

In accordance with the illustrative embodiment, statistics generation module 534 uses the information from databases 428 and 430 to determine, for relevant period of time, the number of tables handled by each server, the tips earned per server, tips earned per server as a percentage of the server's sales, and the tables at which patrons are seated.

Fairness processing module 536 uses the information generated by statistics generation module 534 to make a preliminary recommendation as to scheduling. In the illustrative embodiment, the preliminary recommendation is processed via scheduler 538 to develop a final recommendation.

FIG. 6 depicts a flow chart of the operation of fairness processing module 536 in accordance with an embodiment of the invention. Processing is performed for each employee, or server, via tasks 602, 604, 608, and 610. In some alternative embodiments, processing is performed for a select group of employees (e.g., only those that are scheduled to work on the particular day, etc.). Those skilled in the art will know how to modify the processing to handle select groups of employees. In the illustrative embodiment, the employees are servers in a restaurant establishment, however, those skilled in the art will know how to apply the processing to handle employee scheduling in other establishments and industries.

At task 606, the system ranks the total amount of tips earned, over the relevant period of time, by employee i against the tips earned by other employees being considered for the serving assignment. After all employees have been considered and ranked, the system determines, at task 612, which employee has earned the least amount in tips for the relevant period.

Processing continues in scheduler module 538, wherein other factors before a server recommendation is generated. At task 614, query whether, for the lowest tip-earning server, tips earned as a percentage of sales (for a relevant period of time) exceeds a threshold figure. The period of time can be specified: a shift, a day, a week, a month, etc. The purpose for this query is to identify a poor-performing server. For example, the threshold might be set at 15%, as conservative estimate of tips earned as a percentage of the server's sales (i.e., the amount of the food bill). If the lowest tip earner is receiving gratuities averaging 5% of their sales, that indicates that there is likely to be a performance problem with that server. Fairness processing is not meant to reward someone for poor performance, but rather to compensate them if they have been assigned to less lucrative shifts.

So, if the answer to the query at 614 is “no,” that server is flagged for review, at task 618, by management and deleted at task 620, from the pool of servers to be considered for covering the shift. Processing then loops back to task 612 and the server with the next lowest rank (next lowest amount of tips earned) is identified.

Query, for the next selected server, at task 614, whether tips earned as a percentage of the employee's sales exceed the threshold. If the threshold is met, then that server becomes the preliminary recommendation from fairness processing module 536.

Processing continues in scheduler 538, wherein, at task 616, the system considers any supplementary factors that militate for or against selecting the server under consideration as the final recommendation. For example, a particular employee might have indicated a desire not to work on a particular day or time, which turns out to be the day/time under consideration.

If the serving shift in question is not acceptable for the server, processing loops back to task 620 of fairness processing module 536 to delete the server from consideration. Processing continues at task 612 with a command to select the employee having the next lowest amount of tips earned.

If the serving shift is acceptable for the server under consideration, the preliminary recommendation is the final recommendation, and the system returns a “server recommendation.”

It is to be understood that the disclosure describes a few embodiments and that many variations of the invention can easily be devised by those skilled in the art after reading this disclosure and that the scope of the present invention is to be determined by the following claims.

What is claimed:

1. A point-of-sale system for scheduling servers for a non-routine scheduling assignment by processing payment information, including gratuity, for each table in an establishment using an electronic payment system, the point-of-sale system comprising:
a tablet for receiving at least one food order from each table;
a transceiver for receiving information about the food order from the tablet and receiving payment information, including the gratuity related to the food order, from the electronic payment system;
a memory for storing the received food order information, including the gratuity;
a processor that is configured to schedule servers by performing the steps of:
(a) creating a rank order of servers based on a total amount of gratuities earned by each server during a relevant period of time; and
(b) determining the server that has earned the least amount of gratuities over the relevant period of time and recommending the server to perform the non-routine scheduling assignment.

2. The point-of-sale system of claim 1 wherein the memory includes a server-table assignment database containing information pertaining to a plurality of tables within an establishment, wherein the server-table assignment database organizes the plurality of tables into at least three groups of tables and assigns each server to one of the group of tables.

3. The point-of-sale system of claim 2 wherein the memory includes a table statistics database having automatically populated information pertaining to each table including one or more of: a value for each food order attributable to each table during the relevant period of time, the amount of gratuity earned by each server corresponding to each table during the relevant period of time, and a total amount of tables handled by each server during the relevant period of time.

4. The point-of-sale system of claim 3 further comprising a fairness engine that receives information from the server-table assignment database and the table statistics database and provides the preliminary recommendation of the first server from the group of servers for the non-routine scheduling assignment.

5. The point-of-sale system of claim 4 wherein the fairness engine further comprises:
a statistics generation module that uses information from the server-table assignment database and the table statistics database to determine for the relevant period of time, one or more of: a number of tables handled by each server, the total amount of gratuities earned by each server, the total amount of gratuities earned by each server as a percentage of the total amount of all food orders from the group of tables assigned to each server, and the table associated with each food order;
a fairness processing module that uses information generated by the statistics generation module to determine the preliminary recommendation of the first server from the group of servers for the non-routine scheduling assignment; and
a scheduler module to process the preliminary recommendation of the first server based on performance standards to determine a final recommendation for the non-routine scheduling assignment.

6. The point-of-sale system of claim 5 wherein the fairness processing module ranks the servers from lowest to highest based on the total amount of gratuities each server has earned during the relevant period of time as compared to the total amount of gratuities earned by other servers in the group of servers, and selects the lowest ranking server as the first server.

7. The point-of-sale system of claim 5 wherein the scheduler considers performance standards based on comparing the amount of gratuities earned by the first server during the relevant period of time to a predetermined threshold amount before determining the final recommendation of the first server for the non-routine scheduling assignment.

8. The point-of-sale system of claim 5 wherein the predetermined threshold amount is a percentage of the total amount of all food orders from the group of tables assigned to each server.

9. A computer-implemented method for selecting an employee for a non-routine scheduling assignment based on gratuities earned, the method comprising:
obtaining gratuity information for each table within an establishment from an electronic payment system;
comparing, by a processor, a total amount of gratuities earned by each employee to a total amount of gratuities earned by other employees in a group of employees to recommend a first employee for a non-routine scheduling assignment, by
obtaining the amount of gratuities earned by each employee during a relevant period of time,
rank order the group of employees based on the amount of gratuities the employees have earned,
determining the first employee from the group of employees who has earned the least amount of gratuities,
comparing the amount of gratuity earned by the first employee to a predetermined threshold amount, and
recommending the first employee for the non-routine scheduling assignment when the amount of gratuity earned by the first employee equals or exceeds the predetermined threshold amount, and
determining whether the first employee should be assigned to the non-routine scheduling assignment when the comparison recommends the first employee.

10. The method of claim 9 further comprising assigning the first employee for the non-routine scheduling assignment automatically when the amount of gratuity earned by the first employee equals or exceeds the predetermined threshold amount.

11. The method of claim 9 further comprising:
flagging the first employee for management review when the amount of gratuity earned by the first employee is less than the predetermined threshold amount; and
deleting the first employee from the group of employees.

12. The method of claim 11 further comprising:
determining a second employee from the group of employees who has earned the least amount in gratuity over the relevant period of time;
comparing the amount of gratuity earned by the second employee to a predetermined threshold amount;
recommending the second employee for the non-routine scheduling assignment when the amount of gratuity earned by the second employee equals or exceeds the predetermined threshold amount; and
determining whether the second employee should be assigned to the non-routine scheduling assignment when the comparison recommends the second employee.

13. The method of claim 9 wherein determining whether the first employee should be assigned to the non-routine scheduling assignment when the comparison recommends the first employee further comprises:
receiving scheduling preference information from one or more employees, wherein the scheduling preference information includes availability details associated with one or more employees over the relevant period of time;
analyzing the scheduling preference information to determine availability of the first employee based on the availability details associated with the first employee; and
assigning the first employee to the non-routine scheduling assignment when availability of the first employee for the non-routine scheduling assignment is confirmed.

14. The method of claim 13 further comprising:
rejecting the first employee for the non-routine scheduling assignment when availability is denied; and
deleting the first employee from the group of employees.

15. The method of claim 13 wherein the availability details associated with one or more employees includes one or more of: a plurality of days or times when the employee is available to serve, physical location details, vacation preferences, or holiday preferences.

16. A non-transitory computer readable medium with computer executable instructions stored thereon executed by a processor to perform the method for scheduling employees for a non-routine scheduling assignment based on fairness processing, the method comprising:
(a) accessing a database in the computer including at least, information pertaining to a food order, gratuity information associated with the food order, table information, and server information including scheduling preferences and server-table is assignments;
(b) comparing, by a processor, a total amount of gratuities earned by each employee to a total amount of gratuities earned by other employees in a group of employees to recommend a first employee for a non-routine scheduling assignment, by
calculating, by a statistics generation module in the computer, the total amount of gratuities earned by each employee within the group of employees during a relevant period of time,
calculating, by a fairness processing module in the computer, a rank order of the group of employees based on the amount of gratuities the employees have earned during the relevant period of time, and
determining the first employee from the group of employees who has earned the least amount of gratuities,
comparing, by a scheduler module in the computer, the amount of gratuity earned by the first employee to a predetermined threshold amount, and recommending the first employee for the non-routine scheduling assignment when the amount of gratuity earned by the first employee equals or exceeds the predetermined threshold amount, and
(c) determining whether the first employee should be assigned to the non-routine scheduling assignment when the comparison recommends the first employee.

17. The non-transitory computer readable medium with computer executable instructions stored thereon in accordance with claim 16 wherein the scheduler module further comprises:
flagging the first employee for management review when the amount of gratuities earned by the first employee is less then the predetermined threshold amount; and
deleting the first employee from the group of employees.

18. The non-transitory computer readable medium with computer executable instructions stored thereon in accordance with claim 17 further comprising repeating steps (a) through (c) until an employee is recommended for the non-routine scheduling assignment.

19. The non-transitory computer readable medium with computer executable instructions stored thereon in accordance with claim 16 wherein determining whether the first employee should be assigned to the non-routine scheduling assignment when the comparison recommends the first employee further comprises:
receiving, by the scheduler module from the database, scheduling preference information, wherein the scheduling preference information includes availability details associated with the first employee over the relevant period of time;
analyzing, by the scheduler module, the scheduling preference information to determine availability of the first employee based on the availability details associated with the first employee; and
assigning, by the scheduler module, the first employee to the non-routine scheduling assignment when availability for the non-routine scheduling assignment is confirmed, or
rejecting, by the scheduler module, the first employee for the non-routine scheduling assignment when availability is denied and deleting the first employee from the group of employees.

20. The non-transitory computer readable medium with computer executable instructions stored thereon in accordance with claim 19 further comprising repeating steps (a) through (c) until an employee is assigned for the non-routine scheduling assignment.
